(19) United States
(12) Patent Application Publication
(10) Pub. No.: US 2017/0308390 A1
(43) Pub. Date: Oct. 26, 2017

(54) DATA-RICH ICON

(71) Applicant: Shane Venis, Irvine, CA (US)

(72) Inventors: Shane Venis, Newport Beach, CA (US); Robert Todd Winslow, Aliso Viejo, CA (US); William Charles Fisher, Irvine, CA (US)

(21) Appl. No.: 15/517,954

(22) PCT Filed: Oct. 5, 2015
(86) PCT No.: PCT/US15/54060

§ 371 Date: Apr. 8, 2017

Related U.S. Application Data
(60) Provisional application No. 62/061,277, filed on Oct. 8, 2014.

(51) Int. Cl. G06F 9/44; A63F 13/5372; G06F 9/50; A63F 13/828; G06F 3/0481

(52) U.S. Cl. CPC G06F 9/4443; A63F 13/828; G06F 3/04817; G06F 9/5038; A63F 13/5372; A63F 2250/1063; A63F 2300/61; A63F 2300/5533

(57) ABSTRACT

Instructions are configured to cause at least one processor within a computing device to present and/or update icon(s) on a display. An icon is linked to an application configured to run on the computing device. The icon comprises a representation of each of at least two data items. The at least two data items are associated with an entity. The at least two data items are received from at least one data distribution device over a multi-node network via a communications receiving device. The representation is presented through at least two of the following display elements: a line, a line segment, a line segment designator, and a highlight of at least a portion of one of a plurality of colors associated with the icon.

### CROSS-REFERENCE TO RELATED APPLICATIONS

This application is a National Stage of International Application No. PCT/US15/54060, filed Oct. 5, 2015, entitled “DATA-RICH ICON,” which claims the benefit of U.S. Provisional Application No. 62/061,277, filed Oct. 8, 2014, entitled “Data-Rich Icon,” which are hereby incorporated by reference in their entirety.

### BACKGROUND

Icons may take up valuable space on the display of a computing device. Access to data may require launching an application residing on the computing device to view the data. What is needed is a data-rich icon.

### BRIEF DESCRIPTION OF THE SEVERAL VIEWS OF THE DRAWINGS

FIG. 1 is an example block diagram showing various components of an icon and the interconnected devices that share data as per an aspect of some of the various embodiments.

FIG. 2 is a block diagram of a computing environment in which aspects of embodiments of the present invention may be practiced.

FIG. 3A, FIG. 3B, FIG. 4A, FIG. 4B, FIG. 5A, FIG. 5B, FIG. 6, FIG. 7, FIG. 8A, FIG. 8B, and FIG. 9 are example diagrams showing various display elements of icon(s) as per an aspect of some of the various embodiments.

### DETAILED DESCRIPTION OF EMBODIMENTS

Embodiments of the present invention relate to data-rich icons.

Some of the various embodiments may include a non-transitory tangible machine readable medium comprising instructions configured to cause at least one processor to present an icon on a display of a computing device. A computer icon is a graphical presentation of at least one object presented on a display of a computing device. The icon may be available to help a user navigate one or more programs stored and/or running on the computing device. Icons may be part of a graphical user interface of the computing device. The display may be sensitive to input. For example, a display may comprise a touchscreen configured to accept touch input or multi-touch gestures from a user. Alternatively, the screen may be a monitor configured to only present information. During the presentation on a monitor, an associated computing device may accept user input from a user via an input device such as a mouse, keyboard, pointing device, voice command, combination thereof, and/or the like. The computing device may comprise, but not be limited to at least one of a personal computer, a server, a portable game console, a remote control, a mobile device, a wearable device, a printer, a music player, a television, a camera, a combination thereof, and/or the like. The computing device may comprise at least one processor. The processor may be configured to execute a multitude of tasks. The tasks may comprise background tasks, foreground tasks, a combination thereof, and/or the like. The processor may be configured to manage hardware registers related to the operation of the display.

According to some of the various embodiments, the icon may be linked to an application configured to run on the computing device. The application may comprise at least part of the instructions configured to cause at least one processor to present the icon. Alternatively, the application may request the presentation of the icon to another application, a library, a function, a combination thereof, and/or the like. The other application may be configured to run on the computing device. The other application may be further configured to cause at least one processor to present a plurality of icons. Each of the plurality of icons may be linked to each of a plurality of applications. The application may be configured to operate as a background task on the computing device. By way of example and not limitation, an icon linked to an application running as a background task may enable a user to see data without the need to bring the application into the foreground. As per an aspect of some of the various embodiments, an icon may be presented concurrently with at least one other icon, the other icon linked to another application.

According to some of the various embodiments, the icon may comprise a representation of each of at least two data items. The representation may be presented in many forms. For example, the representation may be presented along the perimeter of the icon, along the perimeter of a geometric shape contained within the icon, along the perimeter of a portion of the icon, a vertical line within the icon, a horizontal line within the icon, a line bisecting the icon, a combination thereof, and/or the like. By way of example and not limitation, a geometric shape contained within the icon may be a circle, a half circle, a wedge or piece of a circle, a line, a hash mark, an arrow, a square, a combination thereof, and/or the like. By way of example and not limitation, data items may be stored on a machine readable medium associated with the computing device, on a removable machine readable medium, on an external device accessible through a multi-node network, on an external device directly accessible by the computing device, a combination thereof, and/or the like. Data items may be passed between a plurality of applications running on the computing device. Alternatively, data items may be stored on a machine readable medium that is configured to be accessible by each of a plurality of applications.

Some icon embodiments may be related to representing data items associated with an entity. By way of example and not limitation, a user may specify at least one entity within an application to track updates to data items associated with the entity. A user may specify at least one goal associated with an entity, at least one range associated with an entity, a combination thereof, and/or the like. Entities may be added, updated, or deleted by instructions located on the computing device, by instructions received from a data distribution device, by input from a user of the computing device, a combination thereof, and/or the like.

According to some of the various embodiments, the entity may comprise a sporting event, a sporting team, a sporting player, a combination thereof, and/or the like. The entity may comprise an event comprising registrations. By way of example and not limitation, the event may be associated with an on-line service, a calendar, a website, a combination thereof, and/or the like.

Some icon embodiments may be related to representing various types of group information. For example, according to some of the various embodiments, the entity may comprise an associated group of application users, an application user, a place of interest, an application user location, a combination thereof, and/or the like.

The entity may comprise a wearable device user. Alternatively, the entity may comprise a sales item, an auction, a watch list item, a wish list item, a combination thereof, and/or the like. By way of example and not limitation, the sales item, auction, watch list item, and wish list item may be associated with an on-line service, a website, a merchant, a combination thereof, and/or the like.

According to some of the various embodiments, the entity may comprise a calendar. By way of example and not limitation, the calendar may represent an individual, a group of two or more individuals, a team, a business unit, and/or the like.

Some icon embodiments may be related to representing various types of monitoring information. For example, according to some of the various embodiments, the entity may comprise a monitored structure, a monitored person, a monitored device, a monitored pet, a combination thereof, and/or the like. By way of example and not limitation, the monitored structure may be a home, a business, a store, a room in a building, a classroom, a cage, a combination thereof, and/or the like. Monitoring of the entity may employ one or more sensors such as, but not limited to: thermistor(s), accelerometer(s), moisture detector(s), camera(s), electromagnetic detector(s), vibration detector(s), chemical detector(s), combinations thereof, and/or the like.

Some icon embodiments may be related to representing various types of financial trading information. For example, according to some of the various embodiments, the entity may comprise a ticker symbol, a security name, a combination thereof, and/or the like. By way of example and not limitation, the security name may be the name of a publicly traded company, the name of a publicly traded commodity, a private bond, a government bond, an exchange traded fund, a mutual fund, an options contract, and/or the like.

Some icon embodiments may be related to representing various types of financial information. For example, according to some of the various embodiments, the entity may comprise at least one financial account. By way of example and not limitation, the financial account may be a bank account, a credit card account, a PayPal account, an account associated with an electronic currency, an account associated with a line of credit, a merchant exchange account, a combination thereof, and/or the like.

Some icon embodiments may be related to representing various types of game information. For example, according to some of the various embodiments, the entity may comprise a game. By way of example and not limitation, the game may be an electronic game configured to run on a computing device, on a networked device, on a virtual device, on a portable game console, a combination thereof, and/or the like. Games may also be non-electronic, such as for example, a sports game, an academic game (e.g. math challenge, spelling bee, etc.), and/or the like. Yet other games may be a combination of electronic and non-electronic games, such as for example, laser-tag, paint ball, and/or the like.

Some icon embodiments may be related to representing various types of messaging information. For example, according to some of the various embodiments, the entity may comprise an electronic mail account, a messaging account, and/or the like. By way of example and not limitation, the messaging account may be an instant message account, a social media account, SMS messaging associated with a telephone account, a combination thereof, and/or the like. According to some of the various embodiments, the icon may be presented concurrently with at least one other icon comprising a representation of data items associated with another entity.

Some icon embodiments may be related to representing various types of sports information. For example, according to some of the various embodiments, at least one of the at least two data items may comprise a sporting event score, a sporting event score type, a field position, a sporting event status, at least one sporting team statistic, at least one sporting player statistic, a last known field position, a sporting event elapsed time, a sporting event remaining time, a sporting event opponent, a combination thereof, and/or the like. By way of example and not limitation, the score type may comprise a touchdown, a field goal, an extra point, par, birdie, eagle, bogey, a run, a 3 point shot, a goal, a penalty kick, a sprint point, a climbing point, a finish line, a marker, a buoy, a gate, and/or the like. By way of example and not limitation, the sporting event status may comprise a team that has possession, a player who has possession, a player who is leading another player, a player who is at bat, a combination thereof, and/or the like. Furthermore, the sporting event status may comprise a quarter, a half, a period, a set, an inning, a round, a lap, and/or the like. By way of example and not limitation, the field position may comprise a yard line, the end zone, a base, a hole number, a leg number of a multi-leg race, a lane number, a position in a race, a lap number, a course number, a course section, a combination thereof, and/or the like. By way of example and not limitation, the sporting event status may comprise possession, direction of play, a time out, a foul, a penalty, a combination thereof, and/or the like.

Some icon embodiments may be related to representing various types of event information. For example, according to some of the various embodiments, at least one of the at least two data items may comprise a number of registered users for an event, a number of users attending an event, a number of users who have not responded to an invitation to an event, a ratio of users attending an event and users not attending an event, a ratio of users who have responded to an invitation for an event and users who have not responded to an invitation to an event, a number of event comments, a number of post comments, a combination thereof, and/or the like. By way of example and not limitation, the post comments may be associated with a social media post, a blog post, a tweet, a picture, a posted article, and/or the like.

Some icon embodiments may be related to representing various types of user information. For example, according to some of the various embodiments, at least one of the at least two data items may comprise a number of available application users, a number of application users within a predefined radius of a particular location, a distance to a place of interest, a number of application users checked in at a place of interest, a combination thereof, and/or the like. By way of example and not limitation, user information may be related to at least one application that may be a social media application, a sports application, a geo-location application, a hobby application, a vitals monitoring application, combinations thereof, and/or the like. At least one of the at least two data items may comprise at least one vital sign of an application user, at least one wearable device statistic, a combination thereof, and/or the like. By way of example and not limitation, the vital sign may comprise a heart rate, a pulse, an oxygen level, a blood pressure systolic, a blood pressure diastolic, a glucose level, a combination thereof, and/or the like.

Some icon embodiments may be related to representing various types of sales. For example, according to some of the various embodiments, at least one of the at least two data items may comprise a number of item sales, a number of auction item bids, an auction item current bid price, an auction item offer price, an auction item asking price, a time remaining in an auction, a combination thereof, and/or the like. By way of example and not limitation, the asking price may be a buy it now price.

Some icon embodiments may be related to representing various types of calendar items. For example, according to some of the various embodiments, at least one of the at least two data items may comprise an event time, an event date, a time remaining until an event, an event urgency indication, an event type, a combination thereof, and/or the like. By way of example and not limitation, the event type may be a social event, a meeting, an appointment, a conference call, a combination thereof, and/or the like.

Some icon embodiments may be related to representing various types of data items related to monitoring. For example, according to some of the various embodiments, at least one of the at least two data items may comprise a monitoring system status, a monitoring zone status, a monitoring sensor status, a monitoring system sensor statistic, a monitoring system sensor measurement, a monitoring activity status, a combination thereof, and/or the like. By way of example and not limitation, the monitoring system status may comprise armed, disarmed, ready, on, off, alert, a combination thereof, and/or the like. By way of example and not limitation, the monitoring zone may comprise an entry way, a garage door in a home, a room, a window, a loading bay, a safe, and/or the like. The monitoring zone may comprise a portion of an office building, a business, a school, a store, a church, and/or the like. By way of example and not limitation, the monitoring sensor may comprise a thermometer, a barometer, a hygrometer, a motion sensor, a magnetic sensor, a radio frequency sensor, a wind sensor, a rain gauge, a water level sensor, a combination thereof, and/or the like. By way of example and not limitation, the sensor statistic may comprise a highest reading, a lowest reading, a total for a plurality of readings, a combination thereof, and/or the like. By way of example and not limitation, the sensor measurement may comprise a temperature, an open connection, a closed connection, a noise, an absence of noise, a power state, a presence, a combination thereof, and/or the like. By way of example and not limitation, the activity status may comprise quiet, noisy, active, inactive, vertical, horizontal, pulse, no pulse, a combination thereof, and/or the like.

Some icon embodiments may be related to representing various data items related to financial trading. For example, according to some of the various embodiments, at least one of the at least two data items may comprise a security bid price, a security ask price, a security trade price, at least one security statistic, at least one underlying asset statistic, a trading session elapsed time, a trading session time remaining, a combination thereof, and/or the like.

Some icon embodiments may be related to representing various data items related to financial information. For example, according to some of the various embodiments, at least one of the at least two data items may comprise a notice of at least one financial transaction, a number of financial transactions, a financial transaction amount, a financial account balance, a combination thereof, and/or the like.

Some icon embodiments may be related to representing various data items related to games. For example, according to some of the various embodiments, at least one of the at least two data items may comprise at least one game level, at least one game episode, at least one game world, at least one game score, at least one game achievement, at least one game badge, at least one other game player, at least one number of games sent, at least one number of games received, a combination thereof, and/or the like. By way of example and not limitation, the game may be an electronic game configured to run on a computing device, on a networked device, on a virtual device, on a portable game console, a combination thereof, and/or the like.

Some icon embodiments may be related to representing various data items related to monitoring. For example, according to some of the various embodiments, at least one of the at least two data items may comprise a monitored device status, at least one monitored device statistic, a combination thereof, and/or the like.

Some icon embodiments may be related to representing various data items related to messaging. For example, according to some of the various embodiments, at least one of the at least two data items may comprise at least one message count, an unread message count, an urgent message count, a combination thereof, and/or the like.

According to some of the various embodiments, the at least two data items may be received from at least one data distribution device. Data distribution device(s) may, for example, comprise a real-time data receiver configured to collect real-time data from at least one data source. Data distribution device(s) may also comprise a routing module configured to route the real-time data to a plurality of devices. By way of example and not limitation, the two data items may be received as part of a notification, a message, a plurality of messages, a file, a streaming data session, a combination thereof, and/or the like. The at least two data items may be received via at least one push notification from at least one data distribution device. Alternatively, the at least two data items may be pulled from at least one data distribution device. The at least two data items may be received over a multi-node (and/or nodal) network. A multi-nodal network comprises multiple network compatible devices communicating over at least two layers of network communications equipment. In other words, at least some of the network devices are situated in the network such that they pass through at least two nodes in order to communicate with another network device. A node may comprise a connection point, a redistribution point, a communication endpoint (e.g. terminal equipment), and/or the like. A node may comprise an active electronic device attached to a network configured to send, receive, and/or forward information over a communications channel Examples of nodes comprise, but are not limited to: router(s), switch(es), modem(s), network interface(s), hub(s), bridge(s), data terminal equipment (DTE), peripheral devices (e.g. printer(s), scanner(s), camera(s), combinations thereof, and/or the like), host computing devices configured to operate as a node, workstation(s), server(s), combinations thereof, and/or the like.

Data item(s) may be received via a communications receiving device. Transmission of the data items may be initiated by computer instructions associated with the computing device, the data distribution device, another device associated with the multi-node network, and/or the like. Furthermore, the data items may be transmitted according to a fixed schedule. The schedule may be managed by the computing device, the data distribution device, another device associated with the multi-node network, a communications receiving device associated with one or more of the aforementioned devices, a combination thereof, and/or the like. According to some of the various embodiments, the computing device associated with the communications receiving device may comprise at least one processor configured to manage hardware registers related to the operation of the communications receiving device.

Some icon embodiments may be related to representing various data items via display elements. For example, according to some of the various embodiments, the representation of each of the at least two data items may be presented through at least two of the following display elements: a line, a line segment, a line segment designator, a highlight of at least a portion of one of a plurality of colors associated with the icon, a combination thereof, and/or the like. The icons may be designed with display elements intended for updates. According to some of the various embodiments, a display element may present one or more of a progress towards a goal, a portion of a total, a point in a range, at least one number in a set, at least one number exceeding a threshold, a portion of elapsed time, a portion of time remaining, a user score relative to other users, a user position relative to other users, a combination thereof, and/or the like. By way of example and not limitation, the point in a range may comprise a value, a location, a position, a combination thereof, and/or the like. By way of example and not limitation, the set may comprise the zones in a home monitoring system, a group of associated users, a group of associated messages, a combination thereof, and/or the like. By way of example and not limitation, the threshold may comprise value of a financial transaction, a price of a security, a price of an item for sale, a price of an auction item, a combination thereof, and/or the like.

Some icon embodiments may be related to representing various goal related information via display elements. For example, according to some of the various embodiments, a display element may present a progress towards a goal. The goal may comprise a sporting event points spread, a specific value for a sporting team statistic, a specific value for a sporting player statistic, a specific number of registered users for an event, a specific number of application users attending an event, a specific number of available application users, a specific number of application users within a specific radius of a particular location, a specific number of application users within a specific radius of a point of interest, a specific number of application users checked in at a place of interest, a specific value of at least one vital sign of an application user, a specific number of item sales, a specific number of auction item bids, a specific price, a game level, a game episode, a game world, a game score, a game achievement, a game badge, a combination thereof, and/or the like.

Some icon embodiments may be related to representing various range information via display elements. For example, according to some of the various embodiments, a display element may present a location in a range. The range may comprise a proximity to a sporting event scoring zone, a proximity to a finish line, a number of laps, a distance traveled to a user location, a distance traveled to a point of interest, an upper and lower vital sign limit, an upper and lower price limit, a combination thereof, and/or the like.

Display elements may be removed when the representation of one of the at least two data items is no longer needed, when one of the at least two data items has changed, when the entity associated with the two data items has changed, a combination thereof, and/or the like.

According to some of the various embodiments, a line segment designator may comprise a hash mark, a tick mark, a portion of a line offset by at least one color, an individual pixel, a group of pixels, a geometric shape, a circle, a triangle, a square, an arrow, a free form shape, a combination thereof, and/or the like. The line segment designator may be color coded to represent a data item type, an entity, an urgency, a combination thereof, and/or the like. The line segment designator may also comprise a discreet outline color. Line segment designators may present a start, a finish, a progress, and/or a point along one or more line segments.

By way of example and not limitation, the highlight of at least a portion of one of a plurality of colors associated with the icon may be used to show an update to an entity represented by a color in an icon with a plurality of colors.

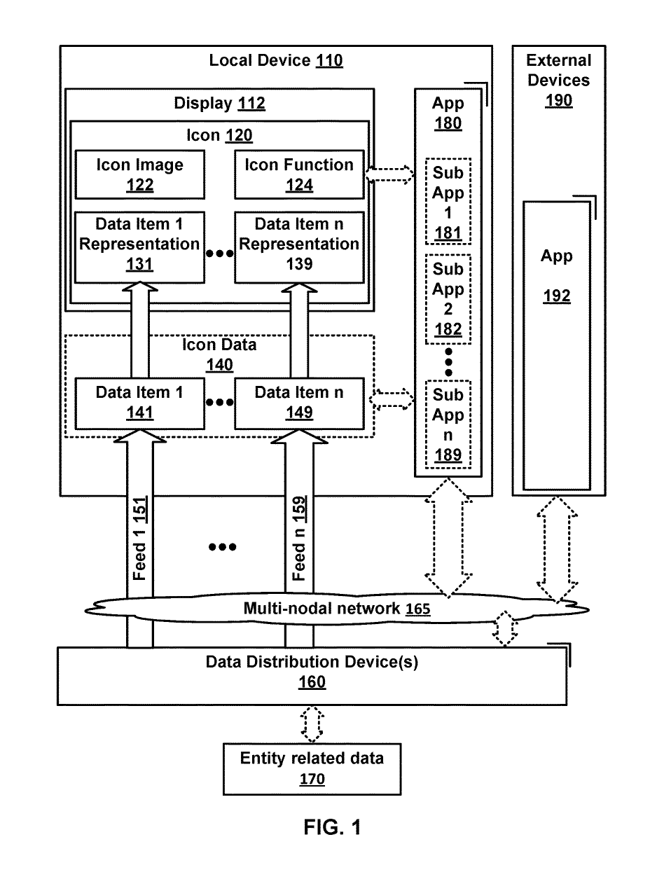

FIG. 1 is an example block diagram illustrating various components of an icon as per an aspect of some of the various embodiments. Icon 120 may be presented on the display 112 of a local device 110. Icon 120 may comprise at least two data item representations (131 . . . 139). Each data item representation may represent one of at least two data items (141 . . . 149). Icon data 140 may comprise the at least two data items (141 . . . 149). Each of the at least two data items (141 . . . 149) may be populated by at least one feed (151 . . . 159). Alternatively, a plurality of data items (141 . . . 149) may be populated by one feed, for example, feed 151. Each feed (151 . . . 159) may originate from at least one data distribution device 160. According to some, various combinations of data feeds (e.g. 151 . . . 159) may originate from various combinations of data distribution devices 160. Data distribution device 160 may communicate with local device 110 through a multi-node network 165.

Icon 120 may be linked to at least one application (app) 180 residing on local device 110. The at least one app may have at least one sub app (181, 182 . . . 189). Each sub app (181, 182 . . . 189) may be associated with an entity. Each entity may be associated with entity related data 170. Entity related data 170 may be populated with data received from at least one data distribution device 160. At least one external device 190 may comprise at least one application (app) 192. The at least one external device 190 may be connected to the multi-node network 165.

The icon 120 may comprise an icon function 124. The icon function 124 may be configured to execute instruction(s) upon activation of the icon 120. The icon function 124 may link the icon 120 to instruction(s) via a pointer. By way of example and not limitation, a user may activate an icon 120 using a pointing device, touch, a voice command, and/or the like. By activating an icon 120, a user may move directly into and out of linked instruction(s) without necessarily needing to know the location or requirements of the instruction(s). The icon function 124 may comprise a pointer to an application, a pointer to an html address, a pointer to an area (e.g. a sub app) of an application associated with an entity, a pointer to a configuration area associated with an application, a pointer to a script, a combination thereof, and/or the like. Alternatively, the icon function 124 may comprise instruction(s) configured to be executed upon the activation of an icon 120. The instruction(s) may comprise an action on local device 110, an action within application 180 running on the local device 110, an action on an external device 190, a combination thereof, and/or the like. Instruction(s) may be related to an entity, an application, one or more data items, a combination thereof, and/or the like.

By way of example and not limitation, action(s) on a local device 110 may comprise instructions to launch an application 180 if the application 180 is not currently running, bring an application 180 to the foreground if the application 180 is running in the background, initiate a data request from a data distribution device 160, start a new electronic message using a messaging application, a combination thereof, and/or the like. By way of example and not limitation, the action within an application 180 running on local device 110 may present at least one configuration option inside the application 180, execute instructions specific to an entity in an application 180, a combination thereof, and/or the like.

By way of example and not limitation, example action(s) on an external device 190 may register for an event, comment on an event, respond to a post, a combination thereof, and/or the like. Example action(s) on an external device 190 may check-in a user at a point of interest. Example action(s) an external device 190 may initiate a measurement of at least one vital sign, arm a monitoring system, disarm a monitoring system, initiate a measurement of at least one sensor, a combination thereof, and/or the like. Example action(s) on external device 190 may place a bid for an auction item, start an order for a security, place a trade for a security, start an electronic commerce transaction, complete an electronic commerce transaction, open an electronic message, a combination thereof, and/or the like.

By way of example and not limitation, configuration option(s) may comprise selecting at least one data item, selecting at least one function, selecting at least one entity, selecting at least one application, accepting user information, accepting information for authorization, a combination thereof, and/or the like.

The icon 120 may comprise an icon image 122. By way of example and not limitation, the icon image 122 may comprise a base image, a plurality of display elements, a graphical representation of at least one number, a graphical representation of at least one text item, at least one additional image, a plurality of colors, a combination thereof, and/or the like. The base image may comprise background elements configured to provide a foundation for the presentation of one or more display elements.

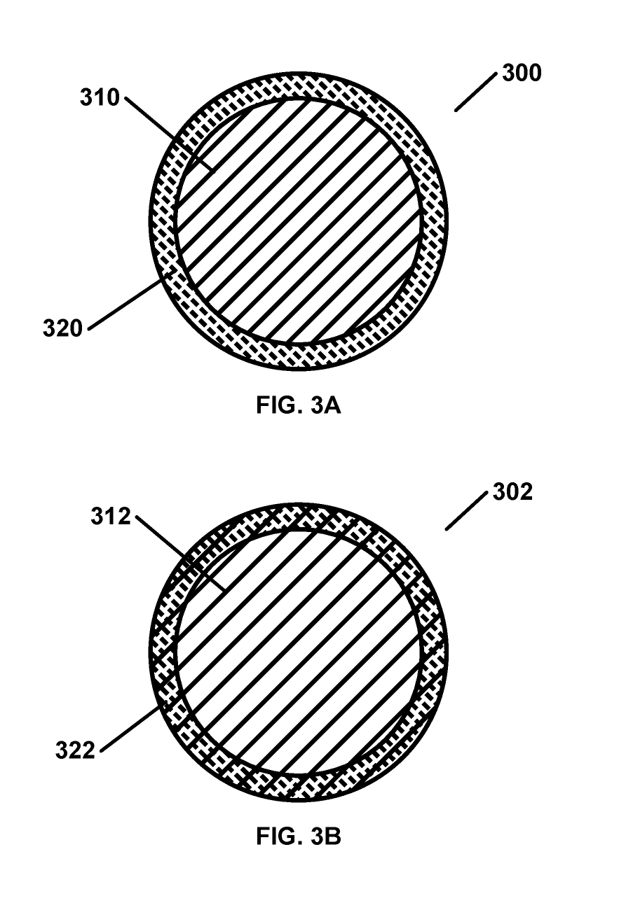

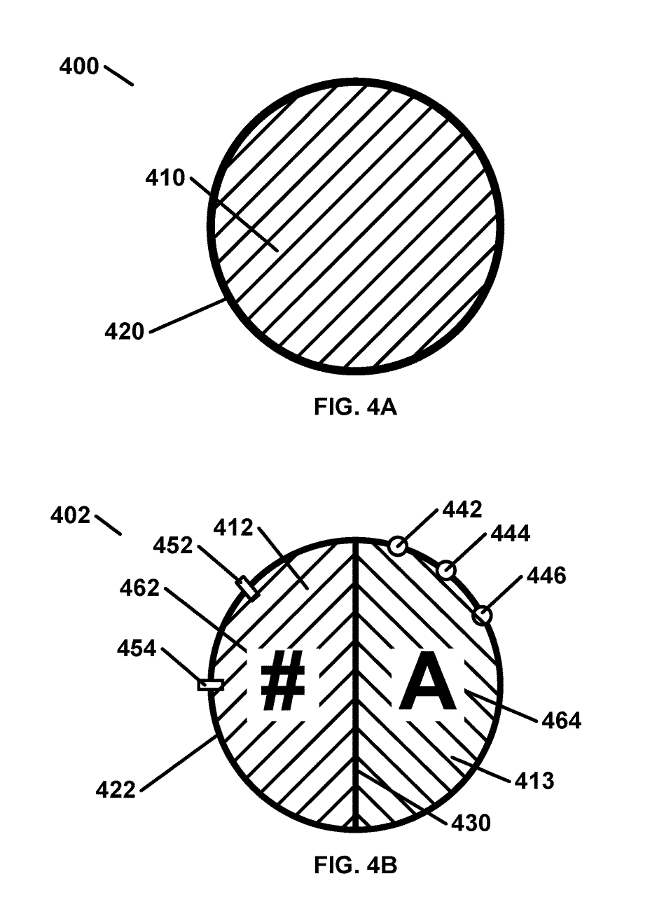

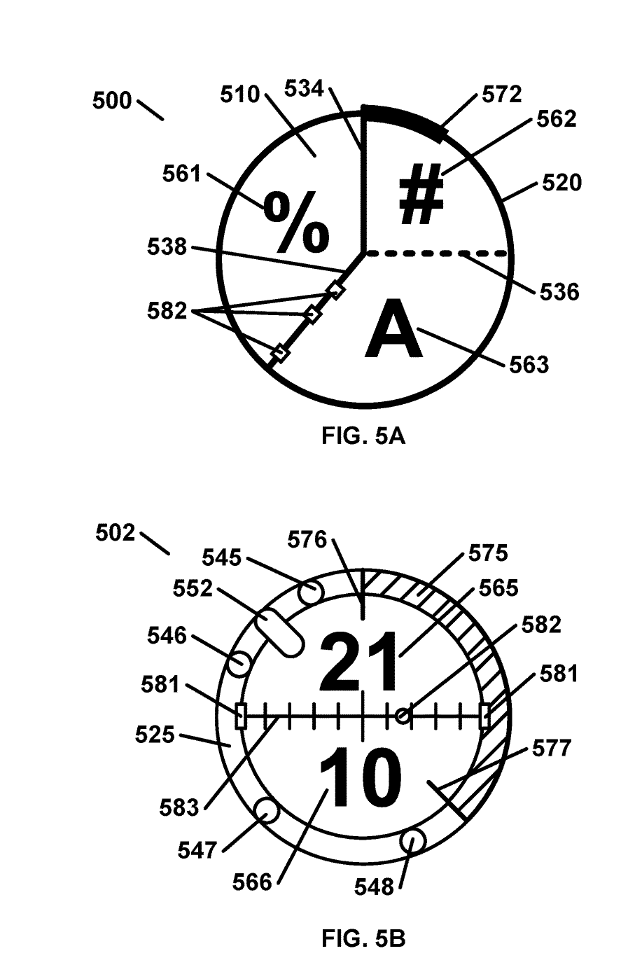

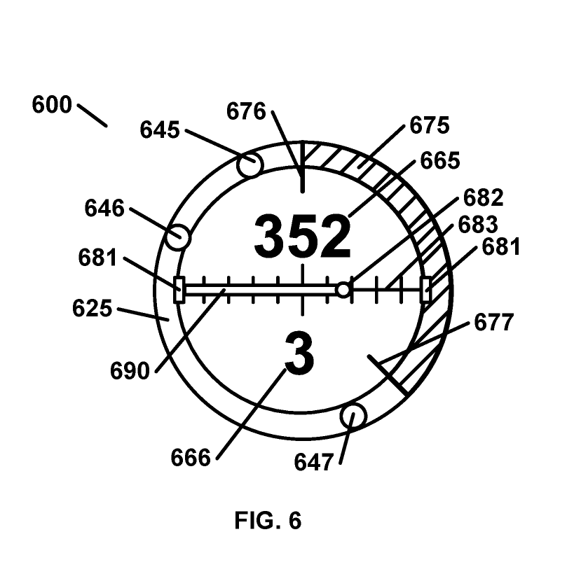

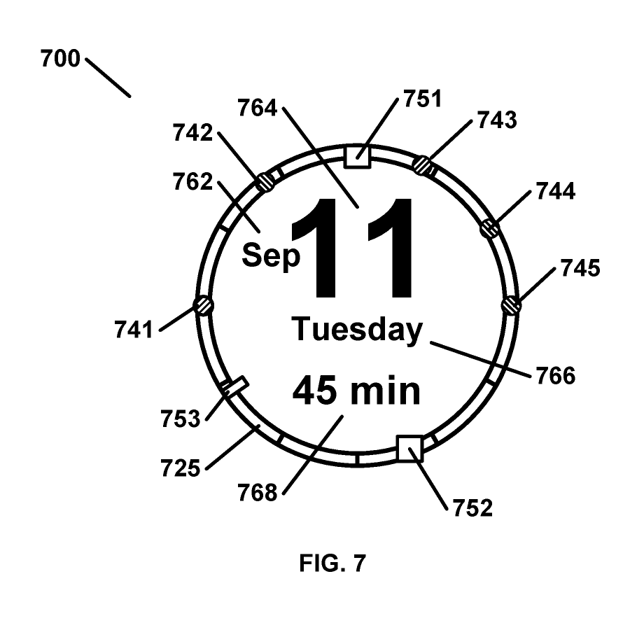

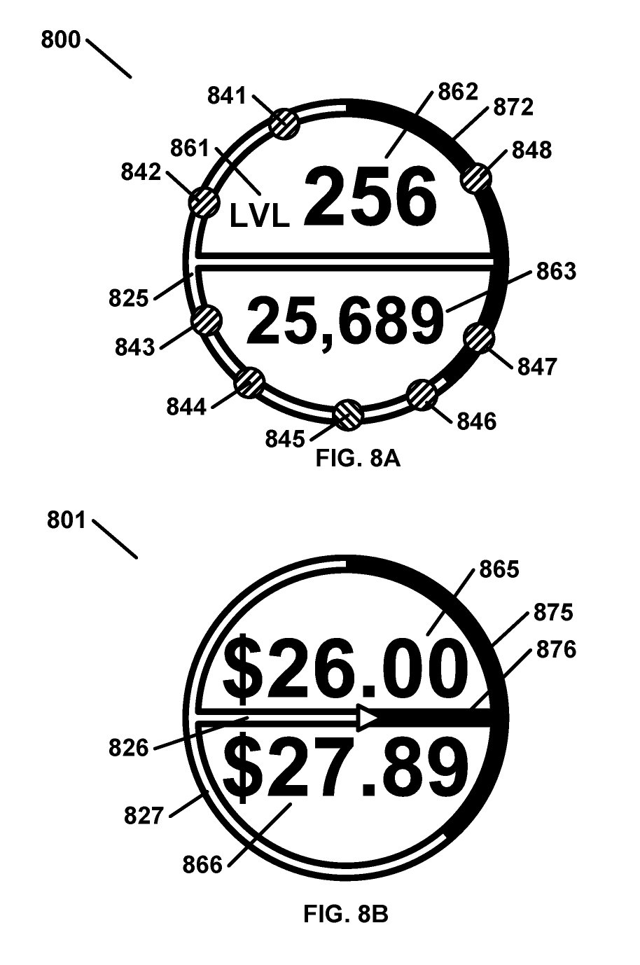

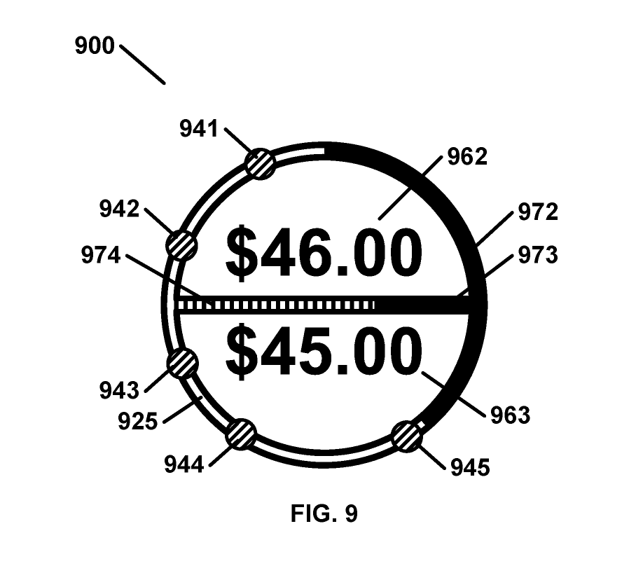

FIG. 3A illustrates an example of various display elements of an icon as per an aspect of some of the various embodiments. Icon 300 may comprise base image 310. Icon 300 may also comprise perimeter 320. Icon 300 may be configured to present one or more line segments related to perimeter 320. For example, a line segment may be configured to present one or more of a progress towards a goal, a portion of a total, a point in a range, a portion of elapsed time, a portion of time remaining, a user score relative to other users, a user position relative to other users, a combination thereof, and/or the like. Similarly, FIG. 3B illustrates another example of various display elements of an icon as per an aspect of some of the various embodiments. Icon 302 may comprise base image 312. Base image 312 may extend to an outer perimeter of perimeter 322.

FIG. 4A illustrates another example of various display elements of an icon as per an aspect of some of the various embodiments. Icon 400 may comprise base image 410. Icon 400 may also comprise perimeter 420. Icon 400 may further comprise a line configured to present one or more line segment designators in relation to perimeter 420. FIG. 4B illustrates another example of various display elements of an icon as per an aspect of some of the various embodiments. Icon 402 may comprise base image sections 412 and 413. Base image section 412 may be designated by a first color and base image section 413 may be designated by a second color. Base image sections 412 and 413 may each represent an entity, a data item, a combination thereof, and/or the like. Icon 402 may comprise vertical line 430. Vertical line 430 may be configured to present one or more line segment designators. Icon 402 may also comprise perimeter 422. Icon 402 may be further configured to present line segment designators 452 and 454 in relation to perimeter 422. Line segment designators 452 and 454 may, for example, be presented as hash marks. Similarly, icon 402 may be configured to present line segment designators 442, 444, and 446 in relation to perimeter 422. Line segment designators 442, 444, and 446 may, for example, be presented as circles on perimeter 422. A line segment designator (e.g. 442, 444, 446, 452, 454) may, for example, be configured to represent a member of a social networking group, a member invited to an event, a member planning to attend an event, a member who has declined to attend an event, a member who has not responded to an event invitation, a post in a social networking group or blog, a new post in a social networking group or blog, combinations thereof, and/or the like. According to some of the various embodiments, icon 402 may further comprise number 462. Number 462 may be related to an entity, a data item, a combination thereof, and/or the like. Icon 402 may further comprise text item 464. Text item 464 may comprise a number. Text item 464 may be related to an entity, a data item, a combination thereof, and/or the like. A number (e.g. 462, 464) may, for example, be configured to represent a number of members in a social networking group, a number of members invited to an event, a number of members planning to attend an event, a number of members who have declined to attend an event, a number of members who have not responded to an event invitation, a number of posts in a social networking group or blog, a number of new posts in a social networking group or blog, combinations thereof, and/or the like.

FIG. 5A illustrates another example of various display elements of an icon as per an aspect of some of the various embodiments. Icon 500 may comprise base image section 510. Icon 500 may also comprise perimeter 520. Perimeter 520 may comprise a line. Icon 500 may be further configured to present at least one line segment 572 in relation to perimeter 520. Icon 500 may further comprise lines 534, 536, and 538. Each of lines 534, 536, and 538 may be configured to present one or more line segments and/or one or more line segment designators 582. Icon 500 may be configured to present number 561 and/or number 562. Icon 500 may also comprise text field 563. Numbers (561, 562) and/or text field 563 may be related to an entity, a data item, a combination thereof, and/or the like. Icon 500 may be configured to present data items related to sensors. For example, icon 500 may present data items related to sensors configured to monitor a home. As another example, icon 500 may present data related to one or more sensors configured to measure one or more vital signs of a user.

FIG. 5B illustrates another example of various display elements of an icon as per an aspect of some of the various embodiments. Icon 502 may comprise perimeter 575. Icon 502 may be configured to present at least one line segment 525 in relation to perimeter 575. Line segment 525 may start at line segment designator 576 and end at line segment designator 577. Line segment designator 577 may be updated to show progress towards a goal, a portion of elapsed time, a portion of a total, a combination thereof, and/or the like. Icon 502 may be further configured to present one or more line segment designators (545, 546, 547, 548, and 552). Line segment designator 552 may present a different type of data item than line segment designators (545, 546, and 547). For example, line segment designator 552 may present a first score type (e.g. a field goal) and line segment designators (545, 546, and 547) may present a second score type (e.g. a touchdown). Furthermore, the location of each of the line segment designators (545, 546, 547, 548, and 552) in relation to perimeter 575 may, for example, present the time during a sporting event (e.g. a football game) when each of the scores took place. Furthermore, each of the line segment designators (545, 546, 547, 548, and 552) may, for example, be color coded to present the one of the two teams that achieved the score. Icon 502 may further comprise a horizontal line 583. Icon 502 may further present, for example, additional markers in relation to horizontal line 583 for a field position (e.g. yard lines). Icon 502 may further comprise line segment designators 581 and 582. Line segment designators 581 may present a scoring zone (e.g. end zone). Line segment designator 582 may present a current field position (e.g. yard line). Icon 502 may be configured to present one or more numbers (565 and 566). Each of the one or more numbers may present, for example, a score for each of two teams competing in a sporting event (e.g. a football game).

FIG. 6 illustrates another example of various display elements of an icon as per an aspect of some of the various embodiments. Icon 600 may comprise a perimeter 675. Icon 600 may be configured to present at least one line segment 625 in relation to perimeter 675. Line segment 625 may start at line segment designator 676 and end at line segment designator 677. Line segment 625 and/or line segment designator 677 may be updated to show progress towards a goal, a portion of elapsed time, a portion of a total, a combination thereof, and/or the like. Icon 600 may be further configured to present one or more line segment designators (e.g. 645, 646, and 647). Line segment designators (e.g. 645, 646, and 647) may, for example, present at least one score type (e.g. a touchdown). Furthermore, the location of each of the line segment designators (e.g. 645, 646, and 647) in relation to perimeter 675 may, for example, present the time during a sporting event (e.g. a football game) when each of the scores took place. Icon 600 may further comprise a horizontal line 683. Icon 600 may further present, for example, additional markers in relation to horizontal line 683 for a field position (e.g. yard lines). Icon 600 may be further configured to present line segment 690 in relation to horizontal line 683. Icon 600 may further comprise line segment designators 681 and 682. Line segment designator 681 may present a scoring zone (e.g. end zone). Line segment designator 682 may present a current field position (e.g. yard line). Line segment 690 and/or line segment designator 682 may be updated to show progress towards a goal (e.g. an end zone), a portion of elapsed time, a portion of a total, a combination thereof, and/or the like. Icon 600 may be configured to present one or more numbers (e.g. 665 and 666). Each of the one or more numbers may present, for example, a sporting player statistic for a player competing in a sporting event (e.g. a football game). For example, number 665 may present a total number of yards (e.g. passing and/or running) achieved in the sporting event, and number 666 may present a total number of scores (e.g. touchdowns) achieved in the sporting event.

FIG. 7 illustrates another example of various display elements of an icon as per an aspect of some of the various embodiments. Icon 700 may comprise a perimeter 725. Icon 700 may be configured to present at least one line segment 753 in relation to perimeter 725. Line segment 753 may be updated to show, for example, a time of day. Icon 700 may be further configured to present one or more line segment designators (e.g. 741, 743, 742, 744, 745, 751, and 752). Line segment designators may be presented with graphical differences (e.g. various colors, and/or shading) to present different types of data items. For example, line segment designators (741 and 743) may be presented with one color to present a different type of data item than line segment designators (742, 744, and 745) presented with a second color and line segment designators (751 and 752) presented with yet another color. For example, line segment designators (741 and 743) may present a first calendar item (e.g. an appointment), line segment designators (742, 744, and 745) may present a second calendar item (e.g. a meeting), and line segment designators (751 and 752) may present a third calendar item (e.g. a call). Furthermore, the location of each of the line segment designators (e.g. 741, 743, 742, 744, 745, 751, and 752) in relation to perimeter 725 may, for example, present the time during the day for each scheduled calendar item. Icon 700 may be further configured to present one or more alpha numeric data items (762, 764, 766, and 768). For example, alpha numeric data item 762 may present a current month. Alpha numeric data item 764 may, for example, present a day of the month. Alpha numeric data item 766 may, for example, present a day of the week. Alpha numeric data item 768 may, for example, present a time remaining until the next calendar item. p FIG. 8A illustrates another example of various display elements of an icon as per an aspect of some of the various embodiments. Icon 800 may comprise a perimeter 872. Icon 800 may be configured to present at least one line segment 825 in relation to perimeter 872. Line segment 825 may be updated to show progress towards a goal (e.g. a level in a game or a high score), a portion of elapsed time, a portion of a total (e.g. a score of a first user compared to a score of a second user), a combination thereof, and/or the like. Icon 800 may be further configured to present one or more line segment designators (e.g. 841, 842, 843, 844, 845, 846, 847 and 848). Line segment designator 845 may be updated to present, for example, the score of a user. Line segment designators (841, 842, 843, 844, 846, 847 and 848) may be updated to present, for example, scores of other users. Icon 800 may be further configured to present one or more data item types 861. Icon 800 may be further configured to present one or more numbers (862 and 863). Number 862 may, for example, present a level of a user or the highest level attained from a plurality of users. Number 863 may, for example, present a score of a user or the highest score attained from a plurality of users.

FIG. 8B illustrates another example of various display elements of an icon as per an aspect of some of the various embodiments. Icon 801 may comprise a perimeter 875. Icon 801 may be configured to present at least one line segment 827 in relation to perimeter 875. Line segment 827 may be updated to show progress towards a goal (e.g. a price target), a portion of elapsed time (e.g. in a trading session), a portion of a total (e.g. a difference in price), a combination thereof, and/or the like. Icon 801 may further comprise a horizontal line 876. Icon 801 may be further configured to present line segment 826 in relation to horizontal line 876. Line segment 826 may be updated to show progress towards a goal (e.g. a price target), a portion of elapsed time (e.g. in a trading session), a portion of a total (e.g. a difference in price), a combination thereof, and/or the like. Icon 801 may be further configured to present one or more numbers (e.g. 865 and 866). Numbers (e.g. 865 and 866) may, for example, present a current ticker price, a price target, a stop loss price, a buy price, a sell price, a sell short price, a limit price, combinations thereof, and/or the like.

FIG. 9 illustrates another example of various display elements of an icon as per an aspect of some of the various embodiments. Icon 900 may comprise a perimeter 972. Icon 900 may be configured to present at least one line segment 925 in relation to perimeter 972. Line segment 925 may be updated to show progress towards a goal (e.g. an asking price), a portion of elapsed time (e.g. duration of an auction), a portion of a total (e.g. a bid price compared to a reserve price), a combination thereof, and/or the like. Icon 900 may be further configured to present one or more line segment designators (e.g. 941, 942, 943, 944, and 945). Line segment designators (e.g. 941, 942, 943, 944, and 945) may be updated to present, for example, auction bids. Icon 900 may further comprise a horizontal line 973. Icon 900 may be further configured to present line segment 974 in relation to horizontal line 973. Line segment 974 may be updated to show progress towards a goal (e.g. an asking price), a portion of elapsed time (e.g. duration of an auction), a portion of a total (e.g. a bid price compared to a reserve price), a combination thereof, and/or the like. Icon 900 may be further configured to present one or more numbers e.g. 962 and 963). Numbers e.g. 962 and 963) may, for example, present an auction price, a reserve price, a bid price, an asking price, combinations thereof, and/or the like. Icon 900 may be configured to highlight at least one number (962 and/or 963) when the time remaining in an auction falls below a threshold.

By way of example and not limitation, instructions configured to cause at least one processor to present an icon on a display of a computing device may be further configured to present at least one configuration option to a user of the computing device. The configuration option may be associated with an application configured to run on the computing device. The application may be configured to present at least one configuration option for at least one icon.

By way of example and not limitation, instructions configured to cause at least one processor to present icon(s) on a display of a computing device running an operating system (e.g. iOS and/or the like) may comprise locating and loading libraries such as one or more developer toolkits, one or more graphics libraries such as Core Graphics, a combination thereof, and/or the like. The instructions may further comprise gathering status information on existing icon(s). The instructions may further comprise creating a View Controller. The instructions may further comprise creating Callbacks, registering Callbacks, creating a polling interface, creating polling methods, a combination thereof, and/or the like for updates to data items. The instructions may further comprise registering Callbacks or implementing polling for at least one authorization response.

By way of example and not limitation, instructions configured to cause at least one processor to present icon(s) on a display of a computing device running an operating system (e.g. iOS and/or the like) may comprise identifying configuration information. The instructions may further comprise accessing configuration information to instantiate configuration values. The instructions may further comprise identifying data items to access. The instructions may further comprise accessing data items to instantiate data item values. The instructions may further comprise rendering icon(s) using graphics primitives. The graphics primitives may be provided by one or more developer toolkits, one or more graphics libraries such as Core Graphics, a combination thereof, and/or the like. The rendering of icon(s) may comprise drawing a base image, drawing at least one background element, drawing at least two display elements, drawing at least one number, drawing at least one text item, a combination thereof, and/or the like.

By way of example and not limitation, instructions configured to cause at least one processor to present icon(s) on a display of a computing device running an operating system (e.g. iOS and/or the like) may comprise receiving a notification from a callback after an update to a data item or receiving a result from a polling request method. The instructions may further comprise repeating the instructions to access data items and render the icon(s). The instructions may further comprise receiving a notification from a callback after an update to a configuration option or receiving a result from a polling request method. The instructions may further comprise repeating the instructions to access configuration information, identifying data items to access, accessing data items, rendering the icon(s), a combination thereof, and/or the like.

Some of the various embodiments may include a non-transitory tangible machine readable medium comprising instructions configured to cause at least one processor to update icon(s). The updating of the icon(s) may comprise receiving an update from the at least one data distribution device. The update may comprise at least one of the at least two data items. The updating of the icon(s) may further comprise creating an updated display element. The updated display element may be based at least in part on the at least one of the at least two data items. The updating of the icon(s) may further comprise providing instructions to cause at least the part of the icon(s) that comprises the updated display element to be presented.

Alternatively, the updating of the icon(s) may comprise selecting a display element. The display element may be based at least in part on the at least one of the at least two data items. The updating of the icon(s) may further comprise providing instructions to cause at least the part of the icon(s) that comprises the display element to be presented.

By way of example and not limitation, the update of icon(s) may be triggered by an update to at least one of the at least two data items, an update to the associated entity, an update to the linked application, an update to the operating system hosting the application, a combination thereof, and/or the like.

The instructions may be further configured to remove, activate, and/or deactivate icon(s). Icon(s) may be removed if no longer needed. Furthermore, icon(s) may be deactivated if the icon(s) will not be needed for some time. Deactivated icon(s) may be activated again when needed.

By way of example and not limitation, the instructions configured to present icon(s), update icon(s), select icon(s), remove icon(s), activate icon(s), deactivate icon(s), a combination thereof, and/or the like, may be part of a developer toolkit. The developer toolkit may comprise at least one library. The library may be instantiated dynamically. The developer toolkit may provide common functions configured to create, update, select, remove, activate, deactivate, and/or present at least one: icon, icon image, display element, a combination thereof, and/or the like. The developer toolkit may require authentication. Alternatively, the developer toolkit may be provided as open source, may be included in at least one operating system configured to run on the computing device, a combination thereof, and or the like. The developer toolkit may provide at least one Application Programming Interface (API). The developer toolkit may require components of one or more operating systems. The one or more operating systems may be required to accept, install, and/or manage the instructions. By way of example and not limitation, the instructions configured to present icon(s), update icon(s), select icon(s), remove icon(s), activate icon(s), deactivate icon(s), and/or the like, may be configured to provide a standard representation of data items across a plurality of icons.

By way of example and not limitation, instructions configured to present icon(s), update icon(s), select icon(s), remove icon(s), activate icon(s), and/or deactivate icon(s) from a display of a computing device running an operating system (e.g. the iOS operating system) may comprise updating at least part of the configuration information associated with at least one icon. The instructions may further comprise repeating the instructions to access configuration information, identifying data items to access, accessing data items, rendering icon(s), a combination thereof, and/or the like. In this example, the rendering of an icon may comprise drawing a base image, drawing at least one background element, drawing at least one display element, drawing at least one number, drawing at least one text item, a combination thereof, and/or the like.

Some of the various embodiments may include a computer implemented system configured to offer a plurality of icons for download to a computing device. At least one of the plurality of icons may be linked to an application. The application may be configured to run on the computing device. At least one of the icons may comprise a representation of each of at least two data items. The at least two data items may be associated with an entity. The at least two data items may be received from at least one data distribution device over a multi-node network via a communications receiving device. The representation may be presented through at least two of the following display elements: a line, a line segment, a line segment designator, and a highlight of at least a portion of one of a plurality of colors associated with icon(s). The system may be further configured to allow a user to select and download at least one of the plurality of icons. The system may be further configured to accept electronic commerce transactions, credits, user authorizations, a combination thereof, and/or the like.

By way of example and not limitation, the computer implemented system may offer a plurality of icons for download through a webpage, through an application running on a data distribution device, through an application running on a device in the multi-node network, a combination thereof, and/or the like. The computer implemented system may be configured to locate any of the following on a computing device: installed icon(s), installed application(s), installed library(ies), installed function(s), at least one specification related to the computing device, a combination thereof, and/or the like. The specification related to the computing device may comprise information on the processor, the operating system, the display, a combination thereof, and/or the like. Alternatively, the plurality of icons may be offered for download through the application linked to the icon(s), through at least one separate application configured to run on the computing device, a combination thereof, and/or the like. Any of the aforementioned applications may be configured to allow a user to select and download at least one of the plurality of icons. Any of the aforementioned applications may be configured to locate any of the following on a computing device: installed icon(s), installed application(s), installed library(ies), installed function(s), at least one specification related to the computing device, a combination thereof, and/or the like.

By way of example and not limitation, a user may be able to search through the plurality of icons for one or more icons based on an entity, an application, at least one characteristic of an entity, at least one characteristic of an application, at least one display element, at least one data item, a combination thereof, and/or the like. The entity may be predefined, selectable by an application, selectable by a user from within an application, a combination thereof, and/or the like. The at least one data item may be predefined, selected by an application, selected by user, a combination thereof, and/or the like.

By way of example and not limitation, the download may include instructions configured to create at least one icon, at least one display element, at least one entity, at least one application, a combination thereof, and/or the like. The download may further include instructions for installing at least one icon, at least one display element, at least one entity, at least one application, a combination thereof, and/or the like. The instructions may be configured to run the installation on the computing device.

By way of example and not limitation, the download to a computing device running an operating system (e.g. the iOS operating system) may comprise instructions configured to locate installed libraries, install necessary libraries, locate functions associated with a developer toolkit, install necessary functions, a combination thereof, and/or the like. The download may further comprise instructions configured to create a graphics context. The download may further comprise instructions configured to create a user interface. The download may further comprise instructions configured to connect to at least one data distribution device. The download may further comprise instructions configured to initiate an authorization procedure. The download may further comprise instructions configured to initiate the creation of configuration information, at least one data item, a combination thereof, and/or the like.

Some of the various embodiments may include a non-transitory tangible machine readable medium comprising instructions configured to cause at least one processor to authorize at least one instance of at least one application residing on a computing device. The instructions may comprise receiving an authorization request from the application prior to presenting an update to an icon associated with the application. The instructions may further comprise performing an authorization procedure based on at least the authorization request. The instructions may also comprise creating an authorization response based at least in part on a result from the authorization procedure. The instructions may further comprise responding to the authorization request with the authorization response.

By way of example and not limitation, the authorization procedure may comprise an acknowledgement from an Application Programming Interface (API). The authorization procedure may comprise instructions to access a user account, access at least one authentication service, verify a user subscription, confirm a user status, validate at least one user certificate, a combination thereof, and/or the like. The user account, user subscription, user status, and/or at least one user certificate may be based on a flat fee, a subscription-based fee, a per-authorization fee, a combination thereof, and/or the like. The user account, user subscription, user status, and/or at least one user certificate may apply to each icon, a plurality of icons, a group of icons, all of the icons installed on the computing device, a combination thereof, and/or the like. The at least one authentication service may be accessible via a multi-node network.

Some of the various embodiments may include a non-transitory tangible machine readable medium comprising instructions configured to cause at least one processor to authorize at least one presentation of at least one icon. The instructions may comprise creating an authorization request prior to presenting the at least one icon. The instructions may further comprise sending the authorization request to at least one authority. The instructions may also comprise receiving an authorization response from the at least one authority. The authorization response may comprise a validation. The instructions may further comprise proceeding with the presentation of icon(s) after verification of a positive validation.

Some of the various embodiments may include a non-transitory tangible machine readable medium comprising instructions configured to cause at least one processor to authorize at least one update to at least one icon. The instructions may comprise creating an authorization request prior to updating the at least one icon. The instructions may further comprise sending the authorization request to at least one authority. The instructions may also comprise receiving an authorization response from the at least one authority. The authorization response may comprise a validation. The instructions may further comprise proceeding with update of icon(s) after verification of a positive validation.

By way of example and not limitation, at least one function associated with a library may accept at least one authorization request, perform at least one authorization procedure, create an authorization response, a combination thereof, and/or the like. The function and/or library may be provided by the developer toolkit, the operating system, a third party, a combination thereof, and/or the like.

Some of the various embodiments may include a non-transitory tangible machine readable medium comprising instructions configured to cause at least one processor to update at least one of a plurality of icon images 122 on a display 112. Each of the plurality of icon images may comprise a representation (131 . . . 139) of each of at least two data items (141 . . . 149). The at least two data items may be associated with an entity. The at least two data items may be received from at least one data distribution device 160 over a multi-node network 165 via a communications receiving device. The representation may be presented through at least two of the following display elements: a line, a line segment, a line segment designator, and a highlight of at least a portion of one of a plurality of colors associated with the at least one icon image. The updating of the at least one icon image may comprise receiving an update from the at least one data distribution device. The update may comprise at least one of the at least two data items. The updating of the at least one icon image may further comprise creating an updated display element based at least in part on the at least one of the at least two data items (141 . . . 149). The updating of the at least one icon image 122 may further comprise providing instructions to cause at least the part of the at least one icon image 122 that comprises the updated display element to be presented.

According to some of the various embodiments, at least one of the plurality of icon images 122 may be associated with an icon 120.

Some of the various embodiments may include a non-transitory tangible machine readable medium comprising instructions configured to cause at least one processor to update at least one of a plurality of icon images 122 on a display 112. Each of the plurality of icon images 122 may comprise a representation (131 . . . 139) of each of at least two data items (141 . . . 149). The at least two data items (141 . . . 149) may be associated with an entity. The at least two data items (141 . . . 149) may be received from at least one data distribution device 160 over a multi-node network 165 via a communications receiving device. The representation may be presented through at least two of the following display elements: a line, a line segment, a line segment designator, and a highlight of at least a portion of one of a plurality of colors associated with the at least one icon image. The updating of the at least one icon image 122 may comprise receiving an update from the at least one data distribution device 160. The update may comprise at least one of the at least two data items (141 . . . 149). The updating of the at least one icon image 122 may further comprise selecting a display element based at least in part on the at least one of the at least two data items (141, . . . 149). The updating of the at least one icon image 122 may further comprise providing instructions to cause at least the part of the at least one icon image 122 that comprises the display element to be presented.

By way of example and not limitation, the at least two data items (141 . . . 149) may be provided through at least one other application 180 configured to run on the computing device 110. The at least one other application may be configured to receive the at least two data items (141 . . . 149) from at least one data distribution device 160 over a multi-node network 165 via a communications receiving device. The update may be received through one or more applications 180 running on the computing device. The computing device may be an external device 190 providing a service through the multi-node network 165. The external device 190 may be considered a network node. The multi-node network may be a network cloud. According to some of the various embodiments, The multi-node network may be a network with a specific configured to support the interconnection of and/or data communications between, for example, external device(s) 190, application(s) 180, local device 110, icon data 140, and data distribution device(s) 160.

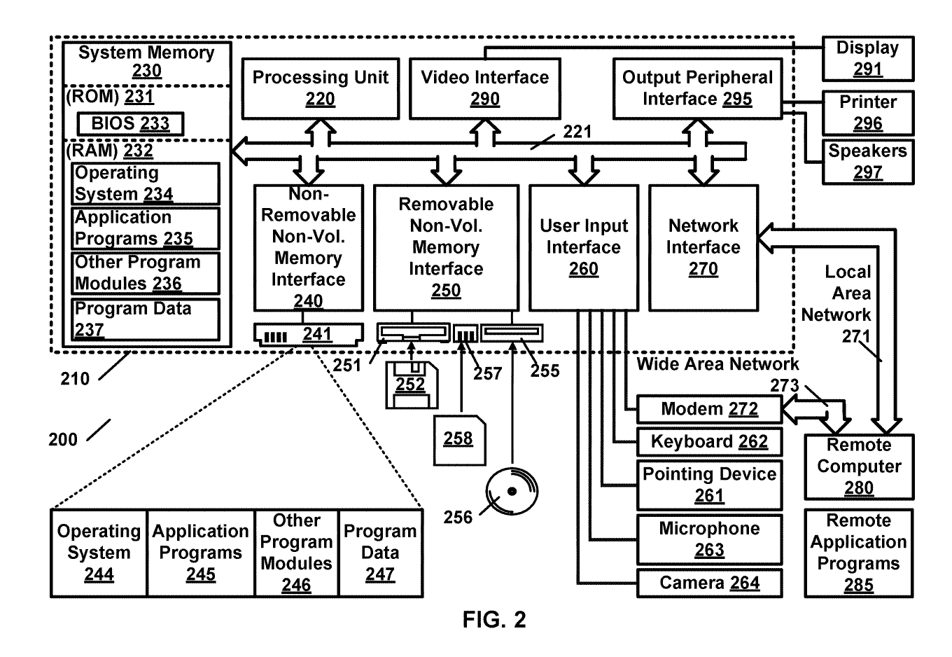

FIG. 2 illustrates an example of a suitable computing system environment 200 on which aspects of some embodiments may be implemented. The computing system environment 200 is only one example of a suitable computing environment and is not intended to suggest any limitation as to the scope of use or functionality of the claimed subject matter. Neither should the computing environment 200 be interpreted as having any dependency or requirement relating to any one or combination of components illustrated in the exemplary operating environment 200.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 2, an example system for implementing some embodiments includes a general-purpose computing device in the form of a computer 210. Components of computer 210 may include, but are not limited to, a processing unit 220, a system memory 230, and a system bus 221 that couples various system components including the system memory to the processing unit 220.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer readable media.

The system memory 230 includes computer storage media in the form of volatile and/or nonvolatile memory such as ROM 231 and RAM 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, a flash drive reader 257 that reads flash drive 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, program data 247, and other program modules 246. Additionally, for example, non-volatile memory may include instructions for presenting and updating icon(s) on a display 291 of computing device 200 and/or the like. Similarly, non-volatile memory may include instructions for causing the presenting and updating of icon(s) on the display of a remote computing device 280 and/or the like.

A user may enter commands and information into the computer 210 through input devices such as a keyboard 262, a microphone 263, a camera 264, and a pointing device 261, such as a mouse, trackball or touch pad. These and other input devices are often connected to the processing unit 220 through a user input interface 260 that is coupled to the system bus, but may be connected by other interface and bus structures, such as a parallel port, game port or a universal serial bus (USB). A display 291 or other type of display device may also be connected to the system bus 221 via an interface, such as a video interface 290. Other devices, such as, for example, speakers 297 and printer 296 may be connected to the system via peripheral interface 295.

The computer 210 is operated in a networked environment using logical connections to one or more remote computers, such as a remote computer 280. The remote computer 280 may be a personal computer, a hand-held device, a server, a router, a network PC, a peer device or other common network node, and typically includes many or all of the elements described above relative to the computer 210. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. The modem 272 may be wired or wireless. Examples of wireless devices may comprise, but are not limited to: Wi-Fi and Bluetooth. In a networked environment, program modules depicted relative to the computer 210, or portions thereof, may be stored in the remote memory storage device. By way of example, and not limitation, FIG. 2 illustrates remote application programs 285 as residing on remote computer 280. It will be appreciated that the network connections shown are exemplary and other means of establishing a communications link between the computers may be used.

The subject matter described includes computer icons. The icons may comprise a representation of a plurality of data items. The data items may be updated over time. Updates to data items may correspond to updates to the representations of the icon. The icon remains a graphical presentation. The icon remains linked to an application. The application may not need to be running for an icon to be presented. The subject matter therefore does not necessarily describe a widget or an applet. A widget is a software application requiring computing resources to present data. Similarly, an applet is a software application requiring computing resources to present data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, flash memory, memory cards, electrically erasable programmable read-only memory (EEPROM), solid state drives, optical disks, barcodes, magnetic ink characters, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, devices have been described as connected to a multi-node network. However, one skilled in the art will recognize that the multi-node network may be represented as one of a variety of server/device relationships over a network such as the internet. For example, a server may be collective based: portable equipment, broadcast equipment, virtual, application(s) distributed over a broad combination of computing sources, part of a cloud, and/or the like. Similarly, for example, a computing device may be a user based client, portable equipment, broadcast equipment, virtual, application(s) distributed over a broad combination of computing sources, part of a cloud, and/or the like. Additionally, it should be noted that, for example purposes, several of the various embodiments comprised instructions. However, one skilled in the art will recognize that many various languages and frameworks may be employed to build and use embodiments of the present invention. For example, languages/frameworks may be based upon C, C++, Objective-C, Linux, Java, Metro, Modern, combinations thereof, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1) A non-transitory tangible machine readable medium comprising: instructions configured to cause at least one processor within a computing device to present an icon on a display, the icon linked to an application configured to run on the computing device, the icon comprising a representation of each of at least two data items, the at least two data items associated with an entity, the at least two data items received from at least one of at least one data distribution device over a multi-node network via a communications receiving device, the representation presented through at least two of the following display elements: a line, a line segment, a line segment designator, and a highlight of at least a portion of one of a plurality of colors associated with the icon.

2) The medium according to claim 1, wherein the computing device is at least one of:
a) a personal computer;
b) a server;
c) a portable game console;
d) a remote control;
e) a mobile device; and
f) a wearable device.

3) The medium according to claim 1, wherein the at least one processor is configured to execute a multitude of tasks, the tasks comprising background tasks and foreground tasks.

4) The medium according to claim 1, wherein the at least one processor is configured to manage hardware registers related to the operation of the communications receiving device and the display.

5) The medium according to claim 1, wherein the application is configured to operate as a background task on the computing device.

6) The medium according to claim 1, wherein the representation is presented in at least one of the following forms:
a) along the perimeter of the icon;
b) along the perimeter of a geometric shape contained within the icon;
c) along the perimeter of a portion of the icon;
d) a vertical line within the icon;
e) a horizontal line within the icon; and
f) a line bisecting the icon.

7) The medium according to claim 1, wherein at least one of the at least two data items comprises at least one of the following:
a) a sporting event score;
b) a sporting event score type;
c) a field position;
d) a sporting event status;
e) at least one sporting team statistic;
f) at least one sporting player statistic;
g) a last known field position;
h) a sporting event elapsed time;
i) a sporting event remaining time; and
j) a sporting event opponent.

8) The medium according to claim 1, wherein at least one of the at least two data items comprises at least one of the following:
a) a number of registered users for an event;
b) a number of users attending an event;
c) a number of users who have not responded to an invitation to an event;
d) a ratio of users attending an event and users not attending an event;
e) a ratio of users who have responded to an invitation for an event and users who have not responded to an invitation to an event;
f) a number of event comments; and
g) a number of post comments.

9) The medium according to claim 1, wherein at least one of the at least two data items comprises at least one of the following:
a) a number of available application users; and
b) a number of application users within a predefined radius of a particular location.

10) The medium according to claim 1, wherein at least one of the at least two data items comprises at least one of the following:
a) a distance to a place of interest; and
b) a number of application users checked in at a place of interest.

11) The medium according to claim 1, wherein at least one of the at least two data items comprises at least one of the following:
a) at least one vital sign of an application user; and
b) at least one wearable device statistic.

12) The medium according to claim 1, wherein at least one of the at least two data items comprises at least one of the following:
a) a number of item sales;
b) a number of auction item bids;
c) an auction item current bid price;
d) an auction item offer price;
e) an auction item asking price; and
f) a time remaining in an auction.

13) The medium according to claim 1, wherein at least one of the at least two data items comprises at least one of the following:
a) an event time;
b) an event date;
c) a time remaining until an event;
d) an event urgency indication; and
e) an event type.

14) The medium according to claim 1, wherein at least one of the at least two data items comprises at least one of the following:
a) a monitoring system status;
b) a monitoring zone status;
c) a monitoring sensor status;
d) a monitoring system sensor statistic;
e) a monitoring system sensor measurement; and
f) a monitoring activity status.

15) The medium according to claim 1, wherein at least one of the at least two data items comprises at least one of the following:
a) a security bid price;
b) a security ask price;
c) a security trade price;
d) at least one security statistic;
e) at least one underlying asset statistic;
f) a trading session elapsed time; and
g) a trading session time remaining.

16) The medium according to claim 1, wherein at least one of the at least two data items comprises at least one of the following:
a) a notice of at least one financial transaction;
b) a number of financial transactions;
c) a financial transaction amount; and
d) a financial account balance.

17) The medium according to claim 1, wherein at least one of the at least two data items comprises at least one of the following:
a) at least one game level;
b) at least one game episode;
c) at least one game world;
d) at least one game score;
e) at least one game achievement;
f) at least one game badge;
g) at least one other game player;
h) at least one number of games sent; and
i) at least one number of games received.

18) The medium according to claim 1, wherein at least one of the at least two data items comprises at least one of the following:
a) a monitored device status; and
b) at least one monitored device statistic.

19) The medium according to claim 1, wherein at least one of the at least two data items comprises at least one of the following:
a) at least one message count;
b) an unread message count; and
c) an urgent message count.

20) The medium according to claim 1, wherein the icon is presented concurrently with at least one other icon, the at least one other icon comprising a representation of data items associated with another entity.

21) The medium according to claim 1, wherein the icon is presented concurrently with at least one other icon, the at least one other icon linked to another application.

22) The medium according to claim 1, wherein the entity comprises at least one of the following:
a) a sporting event;
b) a sporting team; and
c) a sporting player.

23) The medium according to claim 1, wherein the entity comprises an event comprising registrations.

24) The medium according to claim 1, wherein the entity comprises at least one of the following:
a) an associated group of application users; and
b) an application user.

25) The medium according to claim 1, wherein the entity comprises at least one of the following:
a) a place of interest; and
b) an application user location.

26) The medium according to claim 1, wherein the entity comprises a wearable device user.

27) The medium according to claim 1, wherein the entity comprises at least one of the following:
a) a sales item;
b) an auction;
c) a watch list item; and
d) a wish list item.

28) The medium according to claim 1, wherein the entity comprises a calendar.

29) The medium according to claim 1, wherein the entity comprises at least one of the following:
a) a monitored structure; and
b) a monitored person.

30) The medium according to claim 1, wherein the entity comprises at least one of the following:
a) a ticker symbol; and
b) a security name.

31) The medium according to claim 1, wherein the entity comprises at least one financial account.

32) The medium according to claim 1, wherein the entity comprises a game.

33) The medium according to claim 1, wherein the entity comprises at least one of the following:
a) a monitored device; and
b) a monitored pet.

34) The medium according to claim 1, wherein the entity comprises at least one of the following:
a) an electronic mail account; and
b) a messaging account.

35) The medium according to claim 1, wherein each of the at least one data distribution device comprises:
a) a real-time data receiver configured to collect real-time data from a plurality of data sources; and
b) a routing module configured to route the real-time data to a plurality of devices.

36) The medium according to claim 1, wherein the at least two data items are received via at least one push notification from at least one of the at least one data distribution device.

37) The medium according to claim 1, wherein the at least two data items are pulled from at least one of the at least one data distribution device.

38) The medium according to claim 1, wherein at least one display element presents one or more of the following:
a) a progress towards a goal;
b) a portion of a total;
c) a point in a range;
d) at least one number in a set;
e) at least one number exceeding a threshold;
f) a portion of elapsed time;
g) a portion of time remaining;
h) a user score relative to other users; and
i) a user position relative to other users.

39) The medium according to claim 1, wherein at least one display element presents a progress towards a goal, the goal comprising at least one of the following:
a) a sporting event points spread;
b) a specific value for a sporting team statistic;
c) a specific value for a sporting player statistic;
d) a specific number of registered users for an event;
e) a specific number of application users attending an event;
f) a specific number of available application users;
g) a specific number of application users within a specific radius of a particular location;
h) a specific number of application users within a specific radius of a point of interest;
i) a specific number of application users checked in at a place of interest;
j) a specific value of at least one vital sign of an application user;
k) a specific number of item sales;
l) a specific number of auction item bids;
m) a specific price;
n) a game level;
o) a game episode;
p) a game world;
q) a game score;
r) a game achievement; and
s) a game badge.

40) The medium according to claim 1, wherein at least one display element presents a location in a range, the range comprising at least one of the following:
a) a proximity to a sporting event scoring zone;
b) a proximity to a finish line;
c) a number of laps;
d) a distance traveled to a user location;
e) a distance traveled to a point of interest;
f) an upper and lower vital sign limit; and
g) an upper and lower price limit.

41) The medium according to claim 1, wherein the line segment designator comprises one or more of the following:
a) a hash mark;
b) a tick mark;
c) a portion of a line offset by at least one color;
d) an individual pixel;
e) a group of pixels;
f) a geometric shape;
g) a circle;
h) a triangle;
i) a square;
j) an arrow; and
k) a free form shape.

42) The medium according to claim 1, wherein the line segment designator comprises a discreet outline color.

43) The medium according to claim 1, wherein the instructions are further configured to cause the at least one processor to update the icon, the updating of the icon comprising:
a) receiving an update from at least one of the at least one data distribution device, the update comprising at least one of the at least two data items;
b) creating an updated display element based at least in part on the at least one of the at least two data items; and
c) providing instructions to cause at least the part of the icon that comprises the updated display element to be presented.

44) The medium according to claim 1, wherein the instructions are further configured to cause the at least one processor to update the icon, the updating of the icon comprising:
a) receiving an update from at least one of the at least one data distribution device, the update comprising at least one of the at least two data items;
b) selecting a display element based at least in part on the at least one of the at least two data items; and
c) providing instructions to cause at least the part of the icon that comprises the display element to be presented.

45) The medium according to claim 1, wherein the instructions are further configured to:
a) offer a plurality of icons for download to a computing device; and
b) allow a user to select and download at least one of the plurality of icons.

46) The medium according to claim 1, wherein the instructions are further configured to cause at least one processor within a computing device to authorize at least one instance of at least one application residing on the computing device, the instructions comprising:
a) receiving an authorization request from the application prior to presenting an update to an icon associated with the application;
b) performing an authorization procedure based on at least the authorization request;
c) creating an authorization response based at least in part on a result from the authorization procedure; and
d) responding to the authorization request with the authorization response.

47) The medium according to claim 1, wherein the instructions are further configured to cause the at least one processor to authorize at least one presentation of at least one icon, the instructions comprising:
a) creating an authorization request prior to presenting the at least one icon;
b) sending the authorization request to at least one authority;
c) receiving an authorization response from the at least one authority; and
d) proceeding with the icon presentation if the authorization response comprises a positive validation.

48) The medium according to claim 1, wherein the instructions are further configured to cause the at least one processor to authorize at least one update to at least one icon, the instructions comprising:
a) creating an authorization request prior to updating the at least one icon;
b) sending the authorization request to at least one authority;
c) receiving an authorization response from the at least one authority; and
d) proceeding with the icon update if the authorization response comprises a positive validation.

49) The medium according to claim 1, wherein the instructions are further configured to cause the at least one processor to update at least one of a plurality of icon images on the display, at least one of the plurality of icon images associated with the icon, the updating of at least one of a plurality of icon images comprising:
a) receiving an update from at least one of the at least one data distribution device, the update comprising at least one of the at least two data items;
b) creating an updated display element based at least in part on the at least one of the at least two data items; and
c) providing instructions to cause at least the part of the at least one icon image that comprises the updated display element to be presented.

50) The medium according to claim 1, wherein the instructions are further configured to cause the at least one processor to update at least one of a plurality of icon images on the display, at least one of the plurality of icon images associated with the icon, the updating of at least one of a plurality of icon images comprising:
a) receiving an update from at least one of the at least one data distribution device, the update comprising at least one of the at least two data items;
b) selecting a display element based at least in part on the at least one of the at least two data items; and
c) providing instructions to cause at least the part of the at least one image that comprises the display element to be presented.
